(19) United States
(12) Patent Application Publication
(10) Pub. No.: US 2011/0023509 A1
(43) Pub. Date: Feb. 3, 2011

(54) Air conditioning system for vehicles using compressed air power source that recovers energy from vehicle braking

(76) Inventor: Paul William Gardiner, Hong Kong (HK)

Correspondence Address: Paul Gardiner, Flat 7C, Shan Kwong Mansion, No. 7 Shan Kwong Road, Happy Valley, Hong Kong, HK

(21) Appl. No.: 12/804,084

(22) Filed: Jul. 14, 2010

Related U.S. Application Data
(60) Provisional application No. 61/271,941, filed on Jul. 29, 2009.

(51) Int. Cl. B60H 1/32; F25D 9/00

(52) U.S. Cl. 62/133; 62/402

(57) ABSTRACT

The subject system is an air conditioner system for vehicles that uses compressed air as the means of powering the airconditioner refrigerant cycle instead of mechanical or electrical means. The subject system is designed to capture and store braking energy by compressing air and recharging a compressed air reservoir while the vehicle is under deceleration. The air compressor can also be powered from the main vehicle engine or motor to recharge the compressed air reservoir at other times. The stored compressed air system allows the air conditioner to be operated independently of the main vehicle motor. This system does not provide motive power for the vehicle.

### CONTENTS

### 1. Executive Summary

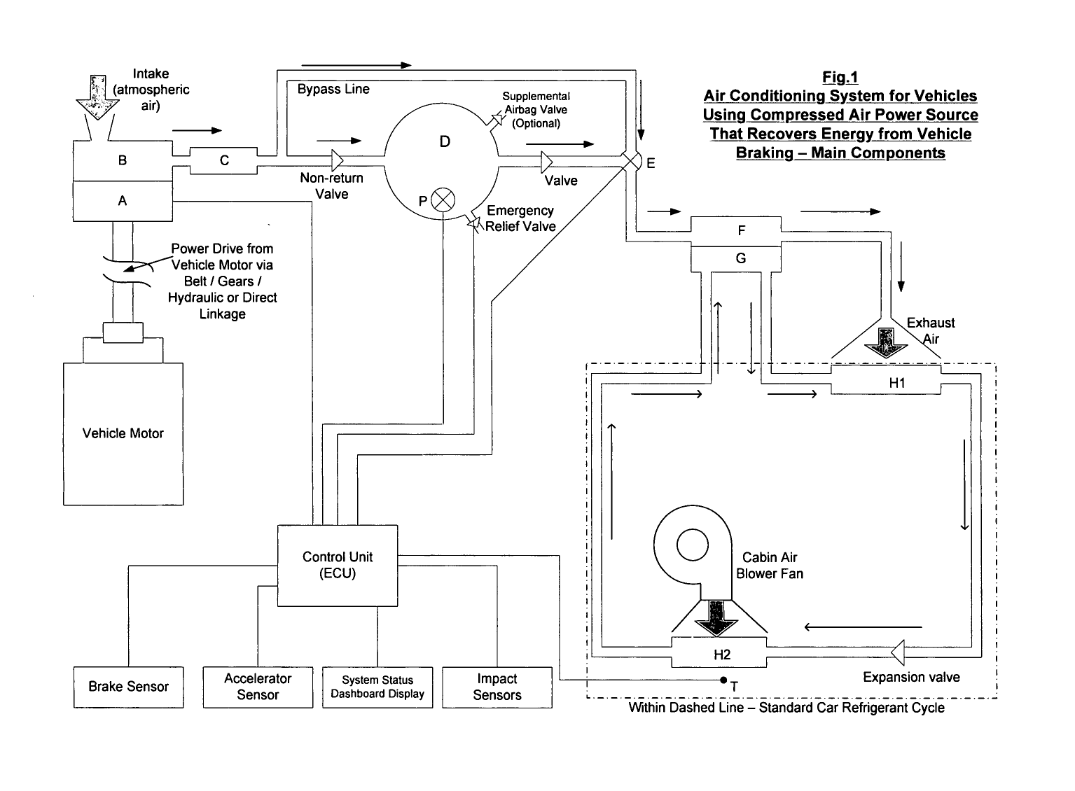

### 2. Key to FIG. 1

### 3. Description of System and Operation

### 4. Table of Operation Modes

### 5. Explanatory Notes

### 1. SUMMARY

The subject system is an air conditioner system for vehicles that uses compressed air as the means of powering the airconditioner refrigerant cycle. This is different to systems that use mechanical or electrical means to power the refrigerant cycle.

The subject system is designed to capture and store braking energy that would otherwise be lost in the form of heat via the wheel brakes of the vehicle. Braking energy is used to compress air and recharge a compressed air reservoir while the vehicle is under deceleration. The air compressor can also be powered from the main vehicle engine or motor.

This system is different from other compressed air vehicle systems in that it does not provide motive power for the vehicle in any way.

The system provides environmental, performance and safety benefits:
kinetic energy that would otherwise be “lost” during braking is captured and stored in the form of compressed air in a reservoir,
the airconditioning unit can operate independently of the vehicle motor using stored compressed air only, allowing the vehicle motor to be shut down;
the airconditioning unit can operate independently of the vehicle motor using stored compressed air only, allowing the air compressor to draw a reduced or no load while the vehicle is under acceleration, releasing additional horsepower for the motor (conversely allowing a smaller engine to be used);
the stored compressed air can be used to operate supplemental emergency safety air bag systems for crash protection.

The design of this system is such that it can immediately implemented on existing “conventional” internal combustion engine vehicles without major redesign while achieving significant fuel economies.

It also allows “automatic start/stop” technology to be used in high ambient temperature environments by allowing continued airconditioner operation even when the engine is temporarily shut down. It can also be used on electric or hybrid-electric vehicles to reduce the load and wear on the electric batteries caused by running a vehicle airconditioner system.

It is estimated that this system using compressed air can save up to 1 liter of fuel for every 100 kilometres under normal driving conditions with the airconditioner operating, increasing to 2 liters of fuel for every 100 kilometres under urban conditions with frequent acceleration and braking. This fuel economy would be further improved with the use of “automatic stop/start” systems which, with this system, can allow the airconditioner to continue running while the vehicle motor is stopped.

In tropical urban environments, the system offers significant environmental benefits by reducing or eliminating the need to operate a polluting internal combustion engine on a parked vehicle simply to run the vehicle's airconditioner. This system allows the airconditioning system to run for a period of time while the internal combustion engine is switched oil eliminating harmful kerbside exhaust pollution and eliminating the heat produced by an idling motor.

The maximum period of operation of the airconditioner is determined inter alia by: the size (volume) and the pressure rating of the compressed air reservoir(s), the ambient outside temperature and the target internal cabin temperature.

This system may also be retrofitted to existing vehicles with suitable modifications.

### 2. EXPLANATION OF FIG. 1

FIG. 1 is a simplified representation of the layout of the main components of the system. The vehicle motor (which can be internal combustion, electric, or some other form of propulsion) drives the system air compressor (B) via a variable clutch (A). The hot compressed air is cooled via the heat exchanger C before passing either to the compressed air reservoir D or to the bypass line. The control valve E controls the amount of air drawn either from the bypass line or from the reservoir D to power the compressed air motor drive F. The air motor F in turn operates the vehicle air conditioner compressor G. Cool exhaust air from F is passed over the heat exchanger H1 to supplement the cooling effect of the heat exchanger. The various components (variable clutch A, control valve E, and relief valves, are controlled by the Electronic Control Unit (ECU) using inputs from the driver via brake and accelerator sensors, impact sensors, pressure sensors (P) and thermostats (T).

### KEY

The descriptions and functions of the components shown in FIG. 1 are:
ECU Electronic Control Unit: the ECU receives data input from various sensors and controls the system via electronic signals (the ECU could also be substituted by mechanical control system achieving the same result)
A Variable clutch/drive controlled from the ECU (in the simplified version, this clutch is a fixed drive)
B Intake Air Compressor driven from Variable Clutch A
C Heat exchanger/radiator (to lose waste heat created in compression cycle)
D Compressed Air Reservoir (size/rating depends on the required interval for independent operation without engine recharging). Either lightweight carbon fibre or similar glass reinforced or similar composite material, or appropriate grade metaL Choice of material depends on these factors: weight, shape and maximum pressure rating. Estimated required rated pressure between 500-1000 psi. Reservoir may comprise single or multiple connected containers.
E Control valve
F Compressed air motor drive
G Standard airconditioner refrigerant compressor driven directly from F compressed air motor drive
H1 Heat exchanger for dumping waste heat in airconditioner refrigerant compression cycle
H2 Heat exchanger inside vehicle cabin in airconditioner refrigerant expansion cycle for providing cooled air to vehicle interior
P Pressure sensor (inside Compressed Air Reservoir D)
T Thermostat (inside cabin, used to adjust cabin temperature)
Brake
Sensor Accelerator Brake sensor linked to brake pedal and sensitive to braking demand
Sensor—Accelerator sensor linked to accelerator pedal and sensitive to acceleration demand
Bypass Line Optional bypass line to directly drive the airconditioner system when maximum recharge of reservoir is also demanded.

### 3. DESCRIPTION OF SYSTEM AND OPERATION

Outside air is drawn into the INTAKE and compressed by the air compressor “B”. The Air Compressor “B” is driven off the vehicle internal combustion engine or electric motor via direct, geared, belt, hydraulic, electric or other drive connection through a Variable Clutch/Drive “A”. The drive from the engine is such that it can supplement “engine braking” by providing additional load on the engine via the variable clutch while the vehicle is decelerating.

The Variable Clutch “A” is a variable power drive that is controlled by the ECU depending on the Operation Modes tabulated below and the Pressure state of “D” (monitored by the pressure sensor P). The ECU will control the Variable Clutch to ensure progressive application and avoid harsh changes to the vehicle motion or engine speed. The Variable Clutch/Drive “A” can be mechanical, hydraulic, electric, electro-magnetic, etc., the important characteristics being that the power transmission from the engine to the compressor “B” can vary from 0% to 100% depending on the operation mode.

Compressed air is either used to recharge the reservoir “D” or to drive the compressed air motor “F” directly via the Bypass Line (optional). Heat created by the compression of the air is lost to the outside via the heat exchanger (or radiator) “C”.

The control Valve “E” is used to control the flow of compressed air to the Compressed Air motor “F”, which drives the Airconditioner Compressor “G”. The operation of Control Valve “E” is determined by the thermostat settings on the airconditioner unit and the energy mode determined by the ECU (see below). Control Valve “E” may be one-way or two-way depending on whether the bypass is fitted.

Exhaust Air from “F” which is below ambient temperature following decompression is used to further cool the airconditioner heat exchanger “H1”, thereby boosting the efficiency of the airconditioner. (To maximise the effectiveness of the cooling airstream, the airflow will be directed starting from the downstream end of the heat exchanger “H1”.)

### 4. TABLE OF OPERATION MODES

Table of Operation Modes

| | Variable Clutch A | Compressed Air | Pressure State of | Airconditioner |
|---|---|---|---|---|
| Vehicle State | Operational State | Motor F Operation | D (Capacity of D) | System State* |
| Engine Start | Disengaged | Using stored | Low to Normal | Low Energy Mode |
| | | compressed air | | |
| | | from D | | |
| Engine Idle | Partially engaged | Using compressed | Low to Normal | Normal Mode |
| | depending on pressure | air from D or via | | |
| | state of D: | (optional) direct | | |
| | Low pressure- | Bypass line | | |
| | engaged to recharge D | | | |
| | Normal pressure- | | | |
| | partially engaged to | | | |
| | maintain pressure in D | | | |
| | High pressure- | | | |
| | disengaged | | | |
| Acceleration | Disengaged | Using compressed | Normal | Normal Mode |
| | | air from D | | |
| Cruise or | Partially engaged | Using compressed | Normal (target) | Normal Mode |
| moderate | depending on pressure | air from D or via | | |
| Deceleration | state of D: | (optional) direct | | |
| | Low pressure- | Bypass line | | |
| | engaged to recharge D | | | |
| | Normal pressure- | | | |
| | partially engaged to | | | |
| | maintain pressure in D | | | |
| | High pressure- | | | |
| | disengaged | | | |
| Braking | Part-fully engaged | Using direct | High/Full | Normal Mode |
| | based on applied | Bypass line in | | |
| | braking force to draw | priority, then | | |
| | maximum available | drawing | | |
| | power to: | compressed air | | |
| | recharge D | from D | | |
| | send compressed air | | | |
| | via bypass line | | | |
| Stationary- | Disengaged | Using compressed | Normal | Normal Mode |
| motor | | air from D | | |
| temporarily | | | | |
| “off” | | | | |
| Parked, motor | Disengaged | Using compressed | Normal to Low | Low Energy Mode |
| “off” | | air from D | | |

(*assumed “on”)

### 5. EXPLANATORY NOTES

### Pressure State of Reservoir “D”

Normal pressure state corresponds to reservoir at 50-70% of maximum capacity (ie: of maximum rated pressure) depending on reservoir size. The “headroom” is to allow for maximum recharging under braking. The ECU can be programmed to allow this “headroom” to increase if the vehicle is travelling at higher speeds, allowing greater recharging capacity under braking. The headroom will therefore depend on several factors, such as the particular vehicle weight and speed (which determine the maximum available kinetic energy that can be recovered), driving style of the owner/driver, and driving conditions (for example, hilly vs flat). The ECU can, if required, be programmed to use “fuzzy logic” to optimise the available “headroom” for recharging the reservoir under braking. The optimal condition is where the reservoir is 99.9% full following completion of a typical braking cycle.

### Normal/Low Energy Mode

Normal mode means the vehicle airconditioner will control the cabin air temperature to the desired settings regardless of the pressure state of the reservoir “D”. Low Energy Mode is Optional and if installed means the vehicle airconditioner will balance maximising the availability of remaining compressed air with internal cooling demand, ie: normally via reducing fan speed and targeting cabin temperature to within the range of the desired setting +3 C.

### Safety Features

The emergency valve is operated to release compressed air rapidly from “D” in case of an accident impact. This is to minimise the risk of uncontrolled decompression of the reservoir. Control is from impact sensors elsewhere in the car via the ECU. Under certain specifications, this compressed air can alternatively be used to inflate additional air bag safety systems, internal or external.

### Simplified Version

The simplified version is mainly mechanical with limited electronic control. The variable clutch is replaced by a fixed or limited variability drive (eg: binary state, on/off), such that the air compressor is continuously operating up to approximately 50%-70% of reservoir capacity, thereafter it operates only when the braking system is applied. This system does not offer all the benefits of the ECU-controlled system, the main benefit being to allow the airconditioner to continue to operate once the main engine is switched “off”. This simplified system may have application to ultra low-cost vehicles in tropical climate or high ambient temperature countries.

As noted above, the ECU can also be replaced by mechanical, electro-mechanical, or other forms of control system which achieve the same, or broadly similar, results as the proposed ECU.

1. An air conditioning apparatus for controlling the temperature of a vehicle cabin, comprising:
(a) an air compressor driven from the vehicle motor
(b) a heat exchanger to dump waste heat from the compressed air
(c) a reservoir to store compressed air
(d) a compressed air powered motor used to drive a refrigerant pump compressor in a refrigerating cycle
(e) a vent for the waste compressed air
(f) a conventional refrigerating cycle equipment comprising a refrigerant pump compressor, heat exchangers, expansion valve and blower unit for providing cooled air to the vehicle interior
(g) an electronic or mechanical control unit.

2. An air conditioning apparatus according to claim 1 which recovers energy during vehicle braking in the form of stored compressed air.

3. An air conditioning apparatus according to claim 1 which utilises stored compressed air to operate the air conditioning system independently of the vehicle's primary motor.

4. An air conditioning apparatus according to claim 1 with a control unit which controls the amount of power drawn from the vehicle motor by the air compressor in an inverse relation to the amount of power demanded by the driver to accelerate the vehicle.

5. An air conditioning apparatus according to claim 1 with a control unit which controls the amount of load placed on the vehicle motor by the air compressor in direct relation to the deceleration of the vehicle.

6. An air conditioning apparatus according to claim 1 with a control unit which controls the amount of compressed air used to operate the compressed air motor for powering the refrigerating cycle compressor.

7. An air conditioning apparatus according to claim 1 which uses vented compressed air to supplement the efficiency of the refrigerating cycle heat exchanger.

8. An air conditioning apparatus according to claim 1 which utilises the compressed air reservoir to provide supplemental emergency air bag inflation for crash protection.
